(19) United States
(12) Patent Application Publication
(10) Pub. No.: US 2016/0162781 A1
(43) Pub. Date: Jun. 9, 2016

(54) METHOD OF TRAINING A NEURAL NETWORK

(71) Applicant: ISIS INNOVATION LTD., Oxford (GB)

(72) Inventors: Timothy LILLICRAP, Oxford (GB); Colin Akerman, Oxford (GB); Douglas TWEED, Oxford (GB); Daniel COWNDEN, Oxford (GB)

(21) Appl. No.: 14/907,560

(22) PCT Filed: Jul. 25, 2014
(86) PCT No.: PCT/IB2014/063430

§ 371 Date: Jan. 25, 2016

Related U.S. Application Data
(60) Provisional application No. 61/858,928, filed on Jul. 26, 2013.

(30) Foreign Application Priority Data
Feb. 17, 2014 (GB) 1402736.1

(51) Int. Cl. G06N 3/08; G06N 99/00

(52) U.S. Cl. CPC G06N 3/082; G06N 99/005

(57) ABSTRACT

A method of training a neural network having at least an input layer, an output layer and a hidden layer, and a weight matrix encoding connection weights between two of the layers, the method comprising the steps of (a) providing an input to the input layer, the input having an associated expected output, (b) receiving a generated output at the output layer, (c) generating an error vector from the difference between the generated output and expected output, (d) generating a change matrix, the change matrix being the product of a random weight matrix and the error vector, and (e) modifying the weight matrix in accordance with the change matrix.

The present invention relates to a method of training a neural network, and a system comprising a neural network. The work leading to this invention had received funding from the European Research Council under ERC grant agreement no. 243274.

### BACKGROUND TO THE INVENTION

Artificial neural networks are computational systems, based on biological neural networks. Artificial neural networks (hereinafter referred to as ‘neural networks’) have been used in a wide range of applications where extraction of information or patterns from potentially noisy input data is required. Such applications include character, speech and image recognition, document search, time series analysis, medical image diagnosis and data mining.

Neural networks typically comprise a large number of interconnected nodes. In some classes of neural networks, the nodes are separated into different layers, and the connections between the nodes are characterised by associated weights. Each node has an associated function causing it to generate an output dependent on the signals received on each input connection and the weights of those connections. Neural networks are adaptive, in that the connection weights can be adjusted to change the response of the network to a particular input or class of inputs.

Conventionally, artificial neural networks can be trained by using a training set comprising a set of inputs and corresponding expected outputs. The goal of training is to tune a network's parameters so that it performs well on the training set and, importantly, to generalize to untrained ‘test’ data. To achieve this, an error signal is generated from the difference between the expected output and the actual output of the network, and a summary of the error called the loss or cost is computed (typically, the sum of squared errors). Then, one of two basic approaches is typically taken to tune the network parameters to reduce the loss: approaches based on either backpropagation of error or perturbation methods.

The first, called back-propagation of error learning (or ‘backprop’), computes the precise gradient of the loss with respect to the network weights. This gradient is used as a training signal and is generated from the forward connection weights and error signal and fed back to modify the forward connection weights. Backprop thus requires that error be fed back through the network via a pathway which depends explicitly and intricately on the forward connections. This requirement of a strict match between the forward path and feedback path is problematic for a number of reasons. One issue which arises when training deep networks is the ‘vanishing gradient’ problem where the backward path tends to shrink the error gradients and thus make very small updates to neurons in deeper layers which prevents effective learning in such deeper networks). And, in hardware implementations of neural network learning this strict connectivity requirement can be extremely difficult to instantiate.

The second approach, called perturbation or reinforcement methods, computes estimates of the gradient of the loss with respect to the network weights. It does this by correlating small changes in the forward connection weights with changes in the loss. Perturbation methods are simple in that they require only the scalar loss signal to be fed back to the network, with no knowledge of the forward connection weights used in the feedback process. In small networks this method can sometimes learn as quickly as backprop. However, the estimate of the gradient becomes worse as the size of the network grows, and does not improve over the course of learning.

### SUMMARY OF THE INVENTION

According to a first aspect of the invention there is provided a method of training a neural network having at least an input layer, a hidden layer and an output layer, and a plurality of forward weight matrices encoding connection weights between successive pairs of layers, the method comprising the steps of:

(a) providing an input to the input layer, the input having an associated expected output,

(b) receiving a generated output at the output layer,

(c) generating an error vector from the difference between the generated output and expected output,

(d) for at least one pair of the layers, generating a change matrix, the change matrix being the product of a fixed random feedback weight matrix and the error vector, and

(e) modifying the forward weight matrix for the at least one pair of the layers in accordance with the change matrix.

The change matrix may be the cross product of the fixed random feedback weight matrix and the error vector.

The method may comprise an initial step of initialising the neural network with random connection weight values.

The method may comprise an initial step of generating the fixed random feedback weight matrix.

The fixed random feedback weight matrix elements may comprise random values from a uniform distribution over [−α, α] where α is a scalar.

The method may comprise iteratively performing steps (a) to (e) for a plurality of input values.

Step (e) may comprise modifying the forward weight matrix encoding connection weights between the pair of layers comprising the input layer and the hidden layer.

Step (e) may comprise modifying the forward weight matrix encoding connection weights between the pair of layers comprising the hidden layer and the output layer

The neural network may comprise a plurality of hidden layers, each hidden layer having an associated forward weight matrix and an associated fixed random backward weight matrix,

the method comprising the steps of;

generating a change matrix for each hidden layer using the associated fixed random weight matrix and;

modifying each forward weight matrix in accordance with the respective change matrix.

The hidden layers may comprise a first hidden layer and a second hidden layer, the second hidden layer being deeper than the first hidden layer, wherein the step of generating a change matrix for the second hidden layer comprises calculating a product of the associated random weight matrix and the error vector.

The hidden layers may comprise a first hidden layer and a second hidden layer, the second hidden layer being deeper than the first hidden layer, wherein the step of generating a change matrix for the second hidden layer comprises calculating a product of the fixed random weight matrix associated with the first hidden layer, the random weight matrix associated with the second hidden layer, and the error vector.

The elements of the fixed random weight matrices may comprise random values from a uniform distribution over [−α, α] where α is a scalar and where α is different for each fixed random weight matrix.

According to a second aspect of the invention is provided a system comprising a neural network where the neural network is trained by a method according to the first aspect of the invention.

### BRIEF DESCRIPTION OF THE DRAWINGS

An embodiment of the invention is described by way of example only with reference to the accompanying drawings, wherein;

FIG. 1 is a diagrammatic illustration of an neural network,

FIG. 2 is an illustration of a known method of training a neural network,

FIG. 3 is an illustration of a method of training a neural network embodying the present invention,

FIG. 4 is a flow chart showing a method of training a neural network embodying the present invention,

FIG. 5 is a graph showing error as a function of training time for the neural network of FIGS. 2 and 3 using different training methods

FIG. 6 is a graph showing the angle between updates made by the method of FIG. 3 and by backpropagation,

FIG. 7 is a graph similar to FIG. 6 showing the angle between updates made by the method of FIG. 3 and by backpropagation changes in individual neurons in the hidden layer of the network of FIG. 2.

FIG. 8 is a graph similar to FIG. 5 showing error as a function of training time for the neural network of FIGS. 2 and 3 using different training methods trained on a standard dataset.

FIG. 9a is a method similar to FIG. 3 illustrating a further method of training an neural network,

FIG. 9b illustrates a method similar to that of FIG. 9a, and

FIG. 10 is shows the results of training a neural network for character recognition using a known method of training neural networks and a method embodying the present invention.

### DETAILED DESCRIPTION OF THE PREFERRED EMBODIMENTS

With specific reference now to the drawings in detail, it is stressed that the particulars shown are by way of example and for purposes of illustrative discussion of the preferred embodiments of the present invention only, and are presented in the cause of providing what is believed to be the most useful and readily understood description of the principles and conceptual aspects of the invention. In this regard, no attempt is made to show structural details of the invention in more detail than is necessary for a fundamental understanding of the invention, the description taken with the drawings making apparent to those skilled in the art how the several forms of the invention may be embodied in practice.

Before explaining at least one embodiment of the invention in detail, it is to be understood that the invention is not limited in its application to the details of construction and the arrangement of the components set forth in the following description or illustrated in the drawings. The invention is applicable to other embodiments or of being practiced or carried out in various ways. Also, it is to be understood that the phraseology and terminology employed herein is for the purpose of description and should not be regarded as limiting.

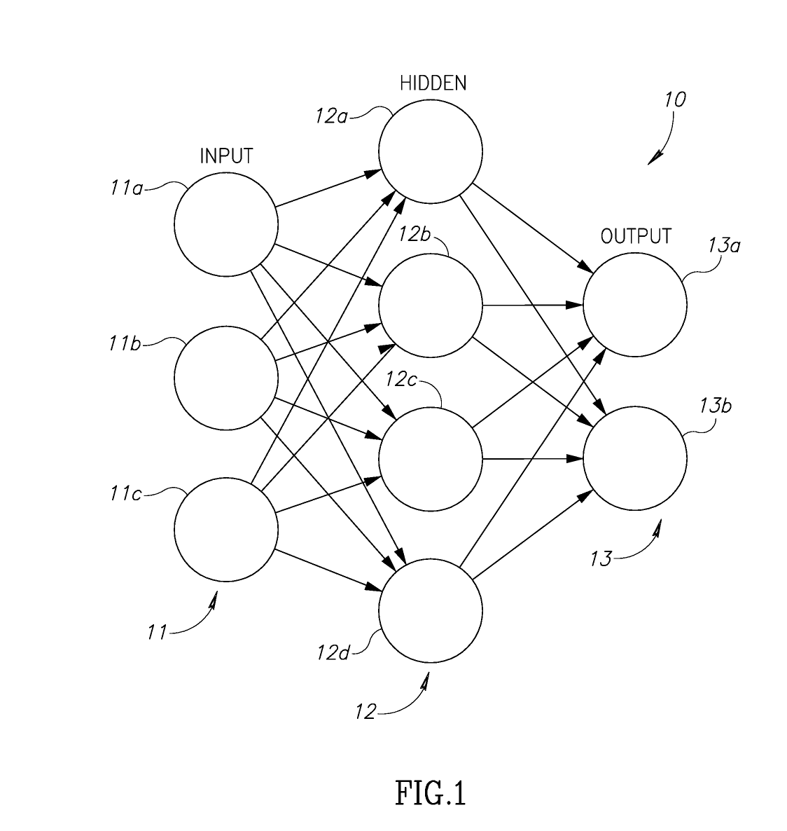

Referring now to FIG. 1, a conventional feedforward neural network is shown at 10. The neural network 10 comprises an input layer 11 to receive data having a plurality of nodes 11a, 11b, 11c, a hidden layer 12 having a plurality of nodes 12a, 12b, 12c, 12d and an output layer 13 having a plurality of nodes 13a, 13b. Each of the nodes of input layer 11 are connected to each of the nodes of hidden layer 12, and each of the nodes of hidden layer 12 are connected each of the nodes of output layer 13. Each of the connections between nodes in successive pairs of layers has an associated weight held in a matrix, and the number of layers and nodes is typically selected or adjusted according to the application the neural network 10 is intended to perform.

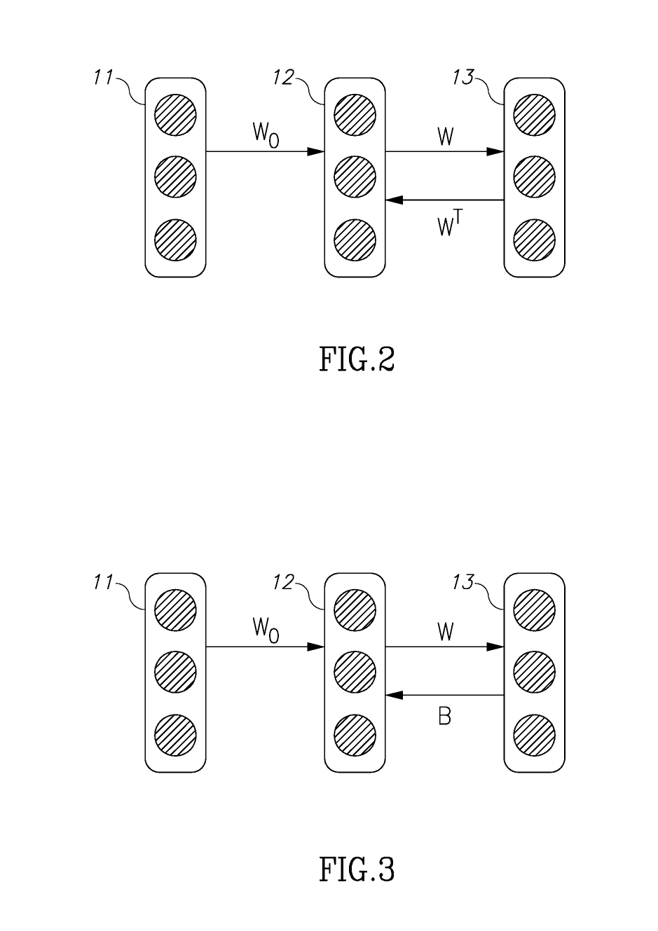

A conventional method of training a neural network 10 is that of backpropagation, illustrated with reference to FIG. 2. FIG. 2 illustrates a 3-layer neural network 10. The matrix of connection weights between input layer 11 and hidden layer 12 is given by W₀ and the matrix of connection weights between hidden layer 12 and output layer 13 is given by W. The output of neural network 11 is given by y=Wh. h is the hidden-unit activity vector, in turn given by h=W₀x, where x is the input to the network 10. In training, the goal is to reduce the squared error, or loss, L=½e^{T}e where the error e=y*−y, where y* is the expected output. For ease of presentation we develop only a linear network here. The same approach applies for the case where the network is non-linear, so that, e.g. y=σ(Wh) and h=σ(W₀x), where σ(•) is a non-linear function (e.g. the standard sigmoid, σ(x)=1/(1+e^{-x}) or σ(x)=tan h(x)).

In conventional backpropagation training, the backpropagation algorithm sends the loss rapidly toward zero. It exploits the depth of the network by adjusting the hidden-unit weights according to the gradient of the loss. The output weights W are adjusted using the formula

$$Δ W = \frac{\partial L}{\partial W} = {eh}^{T}$$

Similarly, the upstream weights W₀ are adjusted using the formula

$$Δ {W}_{0} = ( \frac{\partial L}{\partial h} ) ( \frac{\partial h}{\partial {W}_{0}} ) = ( {W}^{T} e ) {x}^{T}$$

Accordingly, the method proceeds by computing a modification for the output weights, and then using the product of the transpose of the output weight matrix and the error vector to compute a modification for the upstream weight matrix. Consequently, information about downstream connection weights must be used to calculate the changes to upstream connection weights. The computed change matrices are then applied to update the parameters via: W^{t+1}=W^{t}−ηΔW, and W₀^{t+1}=W₀^{t}−ηΔW₀, where t is the time step and η is a scalar learning rate less than 1.

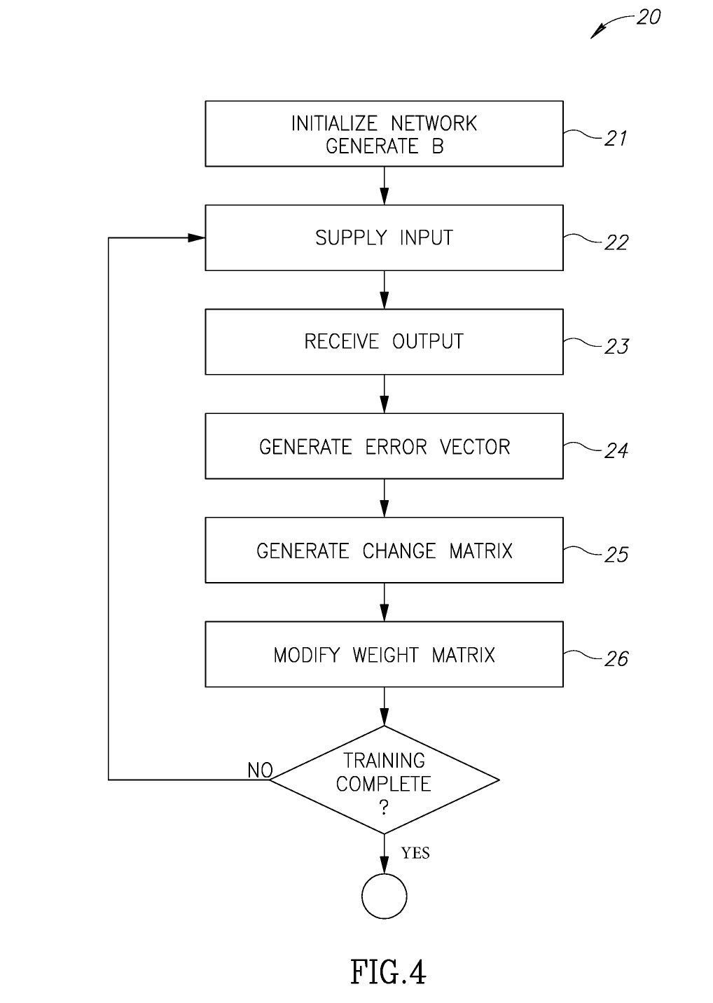

A method embodying the invention is illustrated in FIGS. 3 and 4. The output weights W are adjusted as described above with reference to FIG. 2. However, the upstream weights W₀ are adjusted in accordance with the formula

ΔW₀=(Be)x^{T}

where B is a matrix of fixed random weights. B must have the same dimensions as W^{T}. But B does not contain any information about the forward connection weights, and may be generated in any appropriate way. In the examples described herein, the elements of B comprise random values from a uniform distribution over [−α, α], although any other suitable distribution may be used as appropriate, for example a Gaussian distribution. The method is described herein as ‘feedback alignment’.

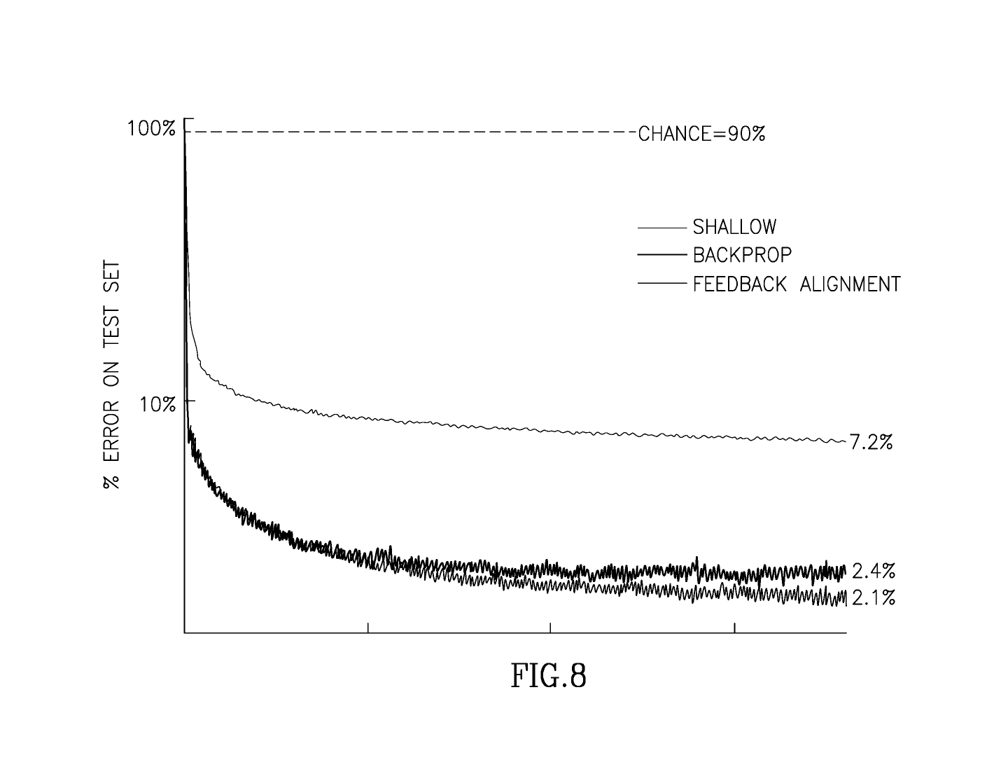

A method of implementing the invention is illustrated in flow diagram 20 in FIG. 8. At step 21, a neural network is initialised, for example by randomly selecting connection weights over the uniform interval [−0.01, 0.01]. A random weight matrix Bis generated by randomly selecting element values over a suitable distribution. At step 22, an input having a corresponding expected output is supplied to the network, and at step 23 an output received from the network. At step 24 an error vector is calculated from the difference between the expected output and the received output, and at step 25 a change matrix calculated from the product of the error vector and the random weight matrix. At step 26 the connection weights of a weight matrix in the network are modified, for example by adding the change matrix and the weight matrix. At step 27, the network is tested to check whether the training is complete, for example when an error value is below a suitable threshold. If not, steps 22 to 26 are repeatedly performed for a plurality of inputs and corresponding expected outputs until step 27 is passed.

In the example of a 3-layer neural network as illustrated above, at step 26 the upstream weight matrix is modified in accordance with the change weight matrix as described, and the output weight matrix may be modified in accordance with conventional backpropagation methods or using feedback alignment, or indeed vice versa.

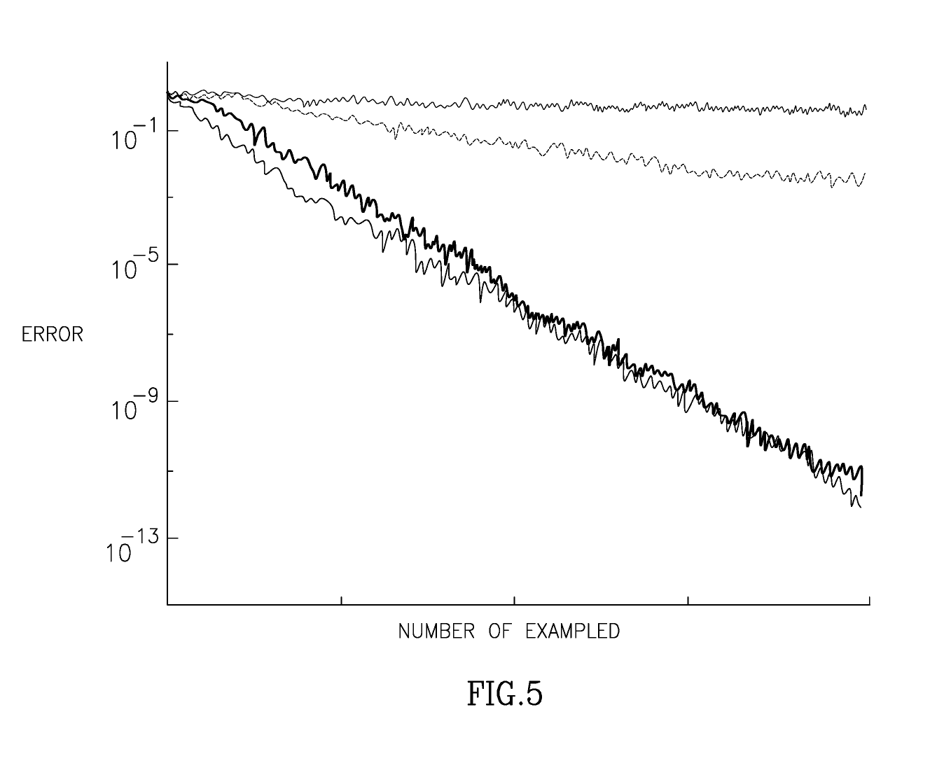

In an example, a 30-20-10 neural network was trained to approximate a linear function. The error is plotted against number of training examples in the graph of FIG. 5. In FIG. 5, the upper line shows the results of adjusting the output weights W only. The next line illustrates a fast perturbation method (node perturbation)). The lower two lines show conventional backpropagation training and training with a random matrix as described above, and it is clear that training the network with backpropagation and with a method embodying the invention are equally effective.

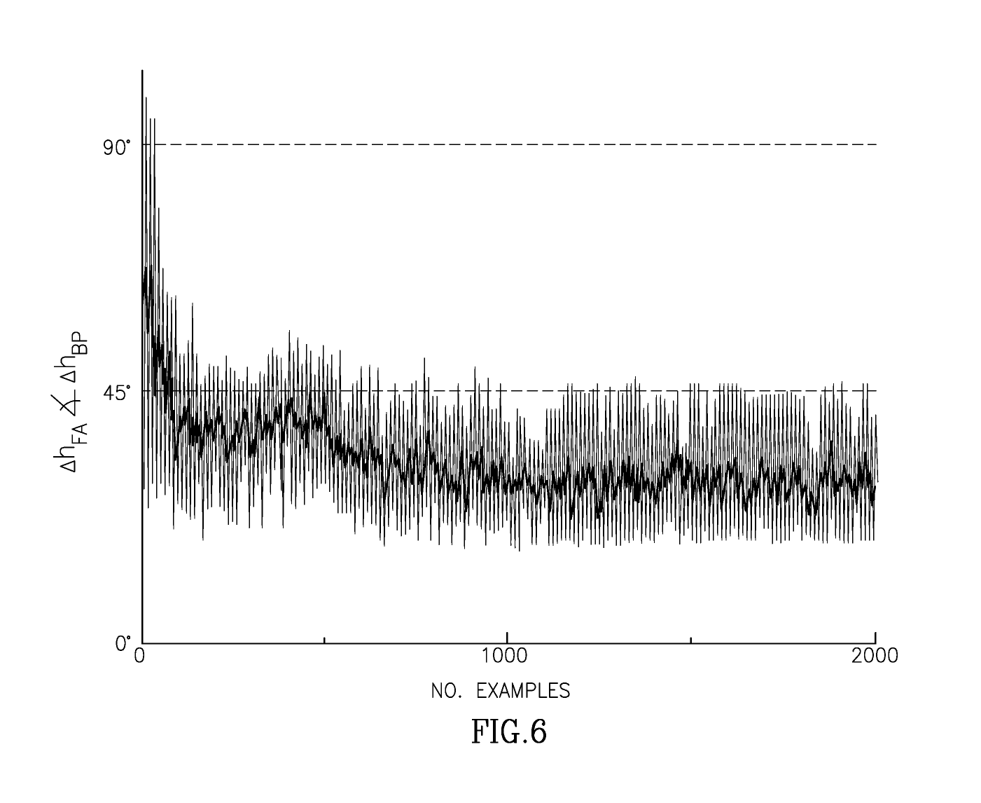

It has been unexpectedly found that using this much simpler formula enables a neural network to trained at least as quickly as using backpropagation. This is unexpected because it is clear that feedback via B will not, at least at first, follow the gradient of the loss. Rather, as is shown in FIG. 6, the updates delivered to the hidden layer improve over time via implicit, self organizing network dynamics. FIG. 6 compares the updates made by backprop and feedback alignment. Initially, feedback alignment takes steps which are approximately orthogonal (i.e. 90 degrees) to those prescribed by backprop, but over time feedback alignment makes changes which are more similar to backprop (the trace corresponds to the feedback alignment learning in FIG. 4). The trace plots the angle between the update sent to the hidden units by backprop, i.e. Δh_{BP}=W^{T} e, and that sent by feedback alignment, i.e. Δh_{FA}=Be. In contrast, backprop always explicitly and precisely computes the gradient, and perturbation methods estimate a noisy approximation of the gradient, but this estimate does not improve over the course of training and degrades with larger network sizes. Feedback alignment shapes the forward weights over time so that the random feedback weights deliver increasingly good updates, and does so even as the size of the networks grows. Thus, feedback alignment represents a third fundamental approach to tuning parameters in a neural network, distinct from both backprop and perturbation methods.

The method is believed to be effective for the following reasons. Any feedback matrix B will be effective, as long as, on average, e^{T}WBe>0. Geometrically this means that the teaching signal sent by the random matrix Be is within 90° of the signal used in backpropagation, W^{T} e, such that the random matrix is pushing the network in roughly the same direction as conventional backpropagation. Initially, updates to W₀ are not effective but quickly improve by an implicit feedback process which alters the relationship between W and B such that e^{T}WBe>0 holds. Over the training process, the direction of changes due to the backpropagation process and the present method converge, suggesting that B begins to act like W^{T}. As B is fixed, the direction is driven by changes in W, suggesting that random feedback weights transmit back useful teaching signals to layers deep in a network.

This method has the advantage that the feedback pathway does not need to be constructed with knowledge of the forward connections. In addition, training using this method has several other advantages. It can act as a natural regularizer (to help generalization) which is more effective than weight decay (i.e. an L2-norm penalty on the weight magnitudes). It can be combined with recently developed regularizers such as ‘dropout’ to give additional benefit.

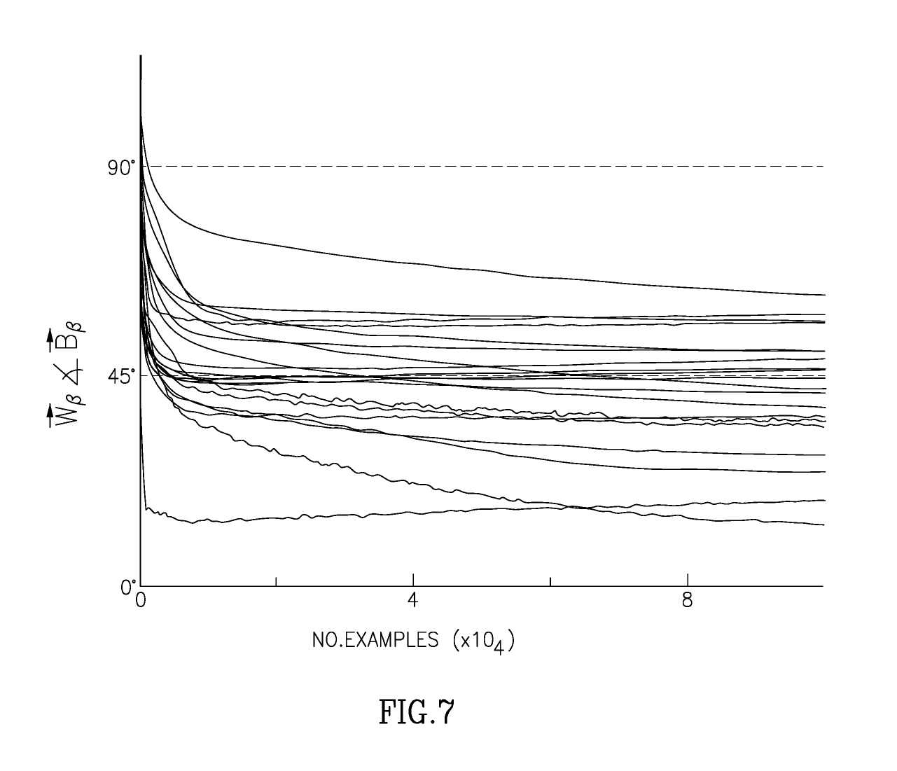

The regularization effect is thought to come from the fact that the forward weights in a network trained with feedback alignment are shaped simultaneously by two requirements: they are required to reduce the loss, but are also encouraged to ‘align’ with the random backward matrices. This ‘alignment’ process is shown in FIG. 7 for 20 randomly selected hidden neurons. FIG. 7 demonstrates the ‘alignment’ process which is unexpected and key to the feedback alignment method. Each trace corresponds to a single neuron in the hidden layer of a 3-layer network and shows the angle between the forward weights vector and fixed backward weights vector for that neuron. For most of the neurons, this angle quickly drops and stays well below 90 degrees. Thus learning dynamics implicitly instruct the forward weights to ‘align’ with the backward weights which are fixed. The angle between the forward weights vector and the fixed random backward weights vector for each neuron tends to decrease over time. In this way feedback alignment places a soft constraint on the forward weight parameters which keeps them from overfitting on training data. This improves generalization performance. FIG. 8 shows a straightforward example of this generalization effect, for a simple 3-layer network with 1000 hidden neurons trained on the MNIST dataset. The graph demonstrates that feedback alignment provides better regularization than standard L2-norm weight decay. A network with a single hidden layer trained with Feedback Alignment on the MNIST handwriting dataset continues to improve on the training set, reaching an error rate of 2.1%. The same network trained with backprop using L2 weight decay does not and plateaus at an error rate of 2.4%. For comparison, the top trace shows performance when only the output weights are trained. Backprop begins to overfit near the end of training, giving worse errors on the test set. Feedback Alignment is just as quick as backprop and consistently reaches a lower error on the test set. In deeper networks with more neurons the same effect holds. On the unenhanced, permutation invariant version of the MNSIT data set, the best reported performance on the test set with a feedforward network using L2-norm penalty regularization is 1.6% error. In this example using feedback alignment an error of 1.3% is consistently achieved. Performance using ‘dropout’ regularization without additional unsupervised training also gives 1.3% error. By combining feedback alignment with dropout, an error rate of 1.12% is achieved.

Because the feedback path is not tied to the forward connections weights, it is simple to avoid the so called ‘vanishing gradient’ problem in deeper networks but at a much lower computational load than is required with the second order approaches (e.g. Hessian-Free methods or LBFGS) which are sometimes used to overcome this issue. Since the feedback pathway for Feedback Alignment is decoupled from the forward pathway it is possible to pick the scale of the forward and backward weights separately. Small weights, which are the preferred way to initialize a network, can be used for the forward weights, while the scale of the backward weights may be chosen to insure that errors flow to the deepest layer without ‘vanishing’. In this fashion, we have successfully trained networks with >10 layers with Feedback Alignment even when all of the forward weights are initialized very close to 0. Backprop fails completely to train deep networks with this initialization since the feedback pathway is tied to the forward pathway and delivers updates to deeper layers which are too small to be useable (this is the ‘vanishing gradient’ problem). Second order methods (i.e. those based on Newton's method, e.g. Hessian-Free methods or LBFGS) are able to overcome the vanishing gradient issue and train networks from this initialization, but these require a great deal more computation than feedback alignment.

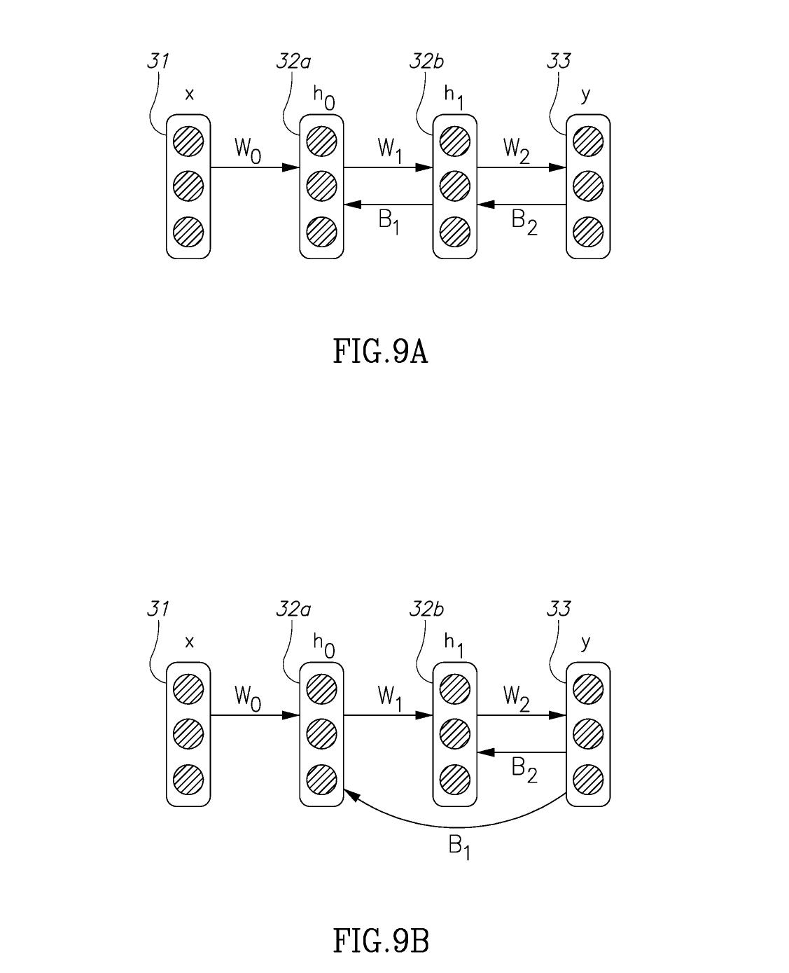

In some applications, neural networks with more than one hidden layer may be desirable as shown in FIGS. 9a and 9b. In these figures, a neural network 30 is shown with an input layer 31, a first hidden layer 32a, a second hidden layer 32b, and an output layer 33. Connection weights between the input layer 31 and the first hidden layer 32a are given by first connection matrix W₀, between the first hidden layer 32a and the second hidden layer 32b by W₁, and between the second hidden layer 32a and the output layer 33 by W₂. In conventional backpropagation, errors are transmitted to the deeper layers in a stepwise manner, such that Δh₀=W₁^{T}W₂^{T}e. In the present case, it has been found that random weight matrices are effective. Each layer 32a, 32b has an associated fixed random feedback weight matrix B₁, B₂ in the example of FIG. 4 generated in step 21. The range [−α, α] for the elements of each fixed random feedback weight matrix may be different for each matrix. As illustrated in FIG. 9a, the change in the hidden layer activity vector can be calculated as Δh₀=B₁B₂e. In some cases, the errors can be propagated directly to deeper layers, in this example such that Δh₀=B₁e. That is, it is possible to indiscriminately broadcast error vectors. All that is required is for each node to receive a scalar that is a randomly weighted sum of the error vector.

In networks with 1 or 2 hidden layers, it is simple to manually select (e.g. by trial and error) a scale for the feedback matrices which produces good learning results. In networks with many hidden layers, it becomes important to choose the scale of the feedback matrices more carefully so that error flows back to the deep layers without becoming too small (i.e. ‘vanishing’) or becoming too large (i.e. ‘exploding’). That is, each Bᵢ feedback matrix should be drawn from a distribution that keeps the changes for each layer of the network within roughly the same range. One simple way to achieve this is to choose the elements for each Bᵢ from the same uniform distribution over [−α, α], and then examine the change matrices produces and adjust the scale of each Bᵢ so that changes made at each layer have roughly the same size. One way to do this is to multiplicatively adjust the elements of each B. If a network has forward weight matrices Wᵢ, with iε{0, 1, . . . , N}, and the corresponding change matrices ΔWᵢ have been computed by first doing a forward pass and then a backward pass with the existing feedback matrices, then we update the Bᵢ with iε{1, . . . , N} in pseudocode as follows:

### for i in {0, 1, . . . , N−1}:

if (mean(abs(ΔWᵢ))>1.0): Bᵢ₊₁=0.9*Bᵢ₊₁

if (mean(abs(ΔWᵢ))<0.001): Bᵢ₊₁=1.1*Bᵢ₊₁

Here abs( ) takes the absolute value of each element in a matrix and mean( ) takes the mean of all the elements in a matrix. In practice, we find that this kind of update to the backward matrices only needs to be applied every few thousand learning steps, and that once good ranges for the elements of Bᵢ have been found, it is possible to discontinue this strategy to save computation.

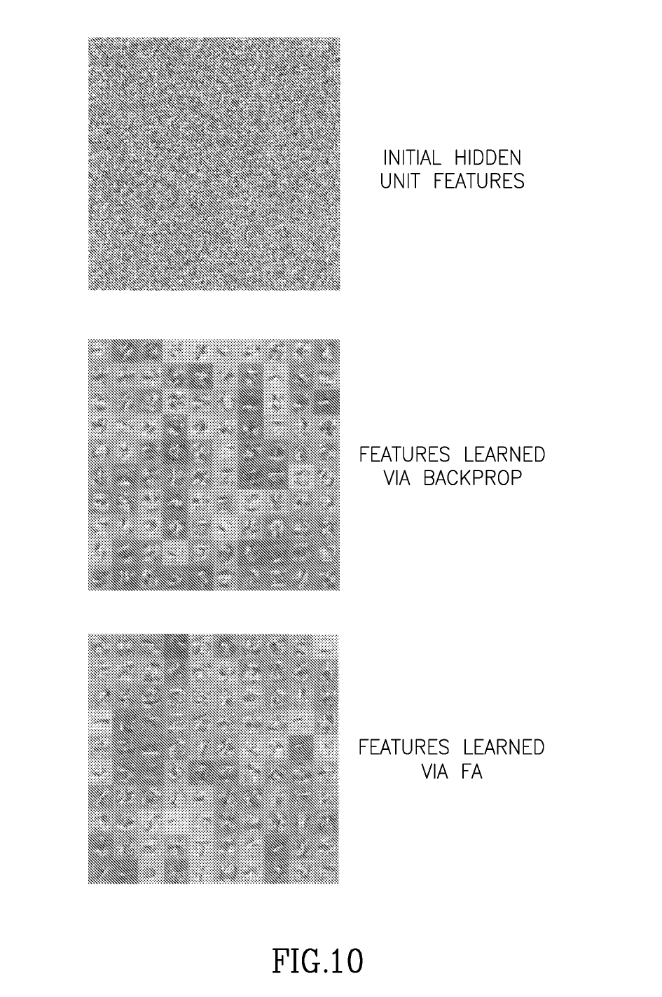

It will be apparent that a system, such as a computer, which has a neural network trained in this manner may have many applications. An example is shown in FIG. 10, in which a 784-1000-10 network with nodes having a sigmoidal response function was trained to categorise handwritten digits. The top image shows the initially hidden unit features, the second image features learned using backpropagation and the third image shows features learnt using the method described herein.

Such a system may be especially suitable for use in the design of special purpose physical microchips (Very Large Scale Integrated chips—VLSI chips). There is a growing interest in producing special purpose physical hardware that is able to compute like a network. Hardware based networks compute faster and can be installed in small devices like cameras or mobile phones. Training these “on-chip” networks has always been difficult with backpropagation or similar learning algorithms because they require precise transport of error signals and writing circuits that obtain this precision is difficult or impossible. Most approaches to this problem have proposed using reinforcement or ‘perturbation’ approaches, but these give much slower learning than backprop as the size of the trained network grows. The method described above removes the need for the kind of precision of connectivity required by backprop, making it suitable for training such hardware versions of neural networks.

In the above description, an embodiment is an example or implementation of the invention. The various appearances of “one embodiment”, “an embodiment” or “some embodiments” do not necessarily all refer to the same embodiments.

Although various features of the invention may be described in the context of a single embodiment, the features may also be provided separately or in any suitable combination. Conversely, although the invention may be described herein in the context of separate embodiments for clarity, the invention may also be implemented in a single embodiment.

Furthermore, it is to be understood that the invention can be carried out or practiced in various ways and that the invention can be implemented in embodiments other than the ones outlined in the description above.

Meanings of technical and scientific terms used herein are to be commonly understood as by one of ordinary skill in the art to which the invention belong, unless otherwise defined.

1. A method of training a neural network having at least an input layer, a hidden layer and an output layer, and a plurality of forward weight matrices encoding connection weights between successive pairs of layers,
the method comprising the steps of:
(a) providing an input to the input layer, the input having an associated expected output,
(b) receiving a generated output at the output layer,
(c) generating an error vector from the difference between the generated output and expected output,
(d) for at least one pair of the layers, generating a change matrix, the change matrix being the product of a fixed random feedback weight matrix and the error vector, and
(e) modifying the forward weight matrix for the at least one pair of the layers in accordance with the change matrix.

2. A method according to claim 1 wherein the change matrix is the cross product of the fixed random feedback weight matrix and the error vector.

3. A method according to claim 1 comprising an initial step of initialising the neural network with random connection weight values.

4. A method according to claim 1 comprising an initial step of generating the fixed random feedback weight matrix.

5. A method according to claim 4 wherein the fixed random feedback weight matrix elements comprise random values from a uniform distribution over [−α, α] where α is a scalar.

6. A method according to claim 1 comprising iteratively performing steps (a) to (e) for a plurality of input values.

7. A method according to claim 1 wherein step (e) comprises modifying the forward weight matrix encoding connection weights between the pair of layers comprising the input layer and the hidden layer.

8. A method according to claim 1 wherein step (e) comprises modifying the forward weight matrix encoding connection weights between the pair of layers comprising the hidden layer and the output layer

9. A method according to claim 1 wherein the neural network comprises a plurality of hidden layers, each hidden layer having an associated forward weight matrix and an associated fixed random backward weight matrix,
the method comprising the steps of;
generating a change matrix for each hidden layer using the associated fixed random weight matrix and;
modifying each forward weight matrix in accordance with the respective change matrix.

10. A method according to claim 9 wherein the hidden layers comprise a first hidden layer and a second hidden layer, the second hidden layer being deeper than the first hidden layer,
wherein the step of generating a change matrix for the second hidden layer comprises calculating a product of the associated random weight matrix and the error vector.

11. A method according to claim 9 wherein the hidden layers comprise a first hidden layer and a second hidden layer, the second hidden layer being deeper than the first hidden layer,
wherein the step of generating a change matrix for the second hidden layer comprises calculating a product of the fixed random weight matrix associated with the first hidden layer, the random weight matrix associated with the second hidden layer, and the error vector.

12. A method according to claim 9 wherein the elements of the fixed random weight matrices comprise random values from a uniform distribution over [−α, α] where α is a scalar and where α is different for each fixed random weight matrix.

13. A system comprising a neural network where the neural network is trained by a method according to any one of the preceding claims.
